(19) United States
(12) Patent Application Publication
(10) Pub. No.: US 2021/0399290 A1
(43) Pub. Date: Dec. 23, 2021

(54) SILICON-BASED COMPOSITE NEGATIVE ELECTRODE MATERIAL AND PREPARATION METHOD THEREOF, AND NEGATIVE ELECTRODE OF LITHIUM ION BATTERY

(71) Applicant: GUANGZHOU AUTOMOBILE GROUP CO., LTD., Guangzhou (CN)

(72) Inventors: Jin Li, Guangzhou (CN); Ao Mei, Guangzhou (CN); Na He, Guangzhou (CN); Qunfeng Wang, Guangzhou (CN); Daoping Tang, Guangzhou (CN); Yifeng Jiao, Guangzhou (CN)

(21) Appl. No.: 17/298,004

(22) PCT Filed: Jan. 11, 2019
(86) PCT No.: PCT/CN2019/071299

§ 371 Date: May 27, 2021

(30) Foreign Application Priority Data
Nov. 27, 2018 (CN) 201811425573.3

(51) Int. Cl. H01M 4/36; H01M 4/38; H01M 4/587; H01M 4/60

(52) U.S. Cl. CPC H01M 4/366; H01M 4/386; H01M 2004/027; H01M 4/602; H01M 4/587

(57) ABSTRACT

The present invention provides a silicon-based composite negative electrode material, including an inner core, a first shell layer, and a second shell layer, wherein the first shell layer covers the inner core; the second shell layer covers the first shell cover; the inner core includes a carbon-silicon composite material; the first shell layer includes an amorphous carbon layer; and the second shell layer comprises includes a conductive polymer layer. Meanwhile, further disclosed in the present invention are a preparation method for the silicon-based composite negative electrode material and a lithium ion battery including the silicon-based composite negative electrode material. The silicon-based composite negative electrode material provided in the present invention can effectively restrain the volume expansion of the inner core, construct a stable solid-liquid interface, form a stable SEI film, and improve the cycle stability and multiplier performance of the lithium ion battery.

### FIELD

The present disclosure relates to technical field of lithium ion battery materials, and specifically relates to a silicon-based composite negative electrode material, a preparation method for the silicon-based composite negative electrode material and a negative electrode of lithium ion batteries.

### BACKGROUND

Currently, commercial lithium ion battery negative electrode materials mainly use graphite-based negative electrode materials, but their theoretical specific capacity is only 372 mAh/g, which does not meet development requirements of higher specific energy and high-power density lithium ion batteries in the future. Therefore, searching for alternative carbon negative electrode materials with high specific capacity has become an important development direction, Due to the highest lithium storage capacity (theoretical specific capacity 4200 mAh/g) and abundance in nature, silicon materials are considered to have the most potential and are expected to become the next generation of lithium ion battery negative electrode materials. However, due to a large volume change during a lithium insertion/desorption process, a destruction of the silicon material structure and a pulverization of the material will lead to a destruction of the electrode structure and cause a silicon active component to lose electrical contact. In addition, a pulverization of the material and the huge volume change will cause a continuous formation of SEI film, resulting in poor electrochemical cycle stability of the battery, and hindering a large-scale application of silicon material as a negative electrode material for lithium ion batteries.

To solve the problems in using silicon as the material for negative electrodes, researchers currently mainly use silicon nanotechnology to reduce the absolute volume expansion of silicon and avoid material powdering. However, nanometerization alone cannot solve the problem of the continuous generation of SEI film caused by the “electrochemical sintering” and intensified side reactions of nano-silicon during the cycle. Therefore, it is necessary to adopt the method of combining nanometerization and compounding to solve various problems in the practical application of silicon by constructing multiple multi-layer composite materials. Most of the currently reported silicon-carbon negative electrode materials are surface-coated core-shell structures. The inner core is a loose and porous structure. The porous structure maintains a morphology of the inner core by providing space for silicon expansion. However, an internal porosity of the structure is too great, although it is helpful to improve the cycle stability of the material, the material is not pressure resistant, and the coating layer strength is low. After multiple cycles, the coating layer cracks, and the electrolyte will continue to be consumed to form SEI film, which in turn reduces a lifecycle of the battery. In addition, a poor transmission performance of electronic and lithium ion of the negative electrode material will also affect a performance of the material. Therefore, to meet the energy density, lifecycle, and rate characteristics of the new generation of high specific energy lithium ion batteries, the capacity, tap density, and rate performance of the silicon carbon negative electrode material must be improved at the same time, while reducing the consumption of electrolyte during the cycle, and establishing a stable solid/liquid interface.

Patent application CN108258230A discloses a hollow structure silicon carbon negative electrode material for lithium ion batteries. The inside of the negative electrode material is hollow, and a wall layer of the negative electrode material comprises an inner wall and an outer wall. The inner wall is formed by a homogeneous composite of nano-silicon and a low-residual carbon source, and the outer wall is a carbon coating layer formed by an organic pyrolysis carbon source. In this structure, the low residual carbon source in the inner wall has a low degree of graphitization and poor conductivity, which affects the rate characteristics of the material. Accompanied by the volume expansion of silicon, silicon easily loses electrical contact, which affects the cycling stability of the material. The outermost carbon coating layer has low strength and is prone to rupture under the design conditions of multiple cycles of charging and discharging or pole piece high-pressure compaction, and a stable SEI film cannot be formed.

Patent application CN103682287A discloses a high-density silicon-based composite negative electrode material for lithium ion batteries embedded with a composite core-shell structure. This achieves silicon-carbon composite material by combining mechanical grinding, mechanical fusion, isotropic pressure treatment, and carbon coating technology. The process of preparing hollowed graphite by mechanical grinding is idealistic, and the actual process is likely to cause graphite to be broken rather than hollowed. The crushing treatment after homogenous pressurization and high-temperature carbonization can easily cause damage to the surface coating, and the ideal core-shell structure cannot be achieved. The particles have large volume expansion, the carbon coating layer has low strength and will break during the cycle and cannot form a stable SEI film.

### SUMMARY

Providing a silicon-based composite cathode material and a preparation method thereof is problematic, particularly for a lithium ion battery cathode, aiming at the problems that the existing shell-type silicon-based cathode material has low coating strength and cannot form a stable SEI film.

To solve the above technical problems, on the one hand, in one embodiment of the present disclosure, a silicon-based composite negative electrode material is disclosed, the material comprising an inner core, a first shell layer, and a second shell layer, The first shell layer covers the inner core, and the second shell layer covers the first shell layer;

the inner core comprises a silicon-carbon composite material;

the first shell layer comprises an amorphous carbon layer;

the second shell layer comprises a conductive polymer layer.

Optionally, the silicon-based composite negative electrode material comprises the following components:

21.5 to 145 parts by weight of the inner core, 1 to 25 parts by weight of the first shell, and 0.5 to 20 parts by weight of the second shell layer.

Optionally, the silicon-carbon composite material comprises nano-silicon, nano-conductive carbon, and graphite.

Optionally, the silicon-carbon composite material comprises the following components: 1 to 50 parts by weight of the nano-silicon, 0.5 to 15 parts by weight of the nano-conductive carbon , and 20 to 80 parts by weight of the graphite.

Optionally, a surface oxide layer SiOx with a thickness less than or equal to 3 nm is formed on a surface of the nano-silicon, wherein 0<X≤2.

Optionally, the nano-conductive carbon comprises one or more of carbon black, graphitized carbon black, carbon nanotubes, carbon fibers, and graphene.

Optionally, a particle size of the nano-silicon is in a range of 10 nm to 300 nm.

Optionally, the graphite comprises one or more of natural graphite, artificial graphite, and mesophase carbon microsphere graphite.

Optionally, the amorphous carbon layer is a soft carbon coating layer or a hard carbon coating layer with a thickness less than or equal to 3 rim.

Optionally, the conductive polymer layer comprises one or more of polyaniline, PEDOT: PSS, polyacetylene, polypyrrole, polythiophene, poly (3-hexylthiophene), poly (p-phenylene vinylene), poly (pyridine), poly (phenylene vinylene), and derivatives of the above said conductive polymers.

Optionally, a thickness of the conductive polymer layer is less than or equal to 3 μm.

One embodiment of the present disclosure provides a preparation method of the silicon-based composite negative electrode material as described above, comprising the following operation steps:

uniformly coating bitumen on a surface of silicon-carbon composite material;

high-temperature carbonization treatment of the bitumen, forming an amorphous carbon layer on the surface of the silicon-carbon composite material; and

covering an outer surface of the amorphous carbon layer with a conductive polymer to obtain a conductive polymer layer and obtaining the composite silicon negative electrode material.

Optionally, the preparation method of the silicon-carbon composite material comprises:

dispersing nano-silicon in a solvent, obtaining nano-silicon dispersion by liquid-phase ball milling, then adding graphite and nano-conductive carbon, uniformly mixing by liquid-phase ball milling, drying and granulating an obtained slurry to obtain the silicon-carbon composite material.

Optionally, in the liquid-phase ball milling process, a grinding medium is a zirconia ball with a diameter of 0.05 mm to 1 mm, a ball-to-material mass ratio is in a range of 2:1 to 20:1, a rotating speed is in a range of 200 rpm to 1500 rpm, a ball milling time lasts in a range of 1 hour to 12 hours, and a material temperature is in a range of 25° C. to 35° C.

Optionally, a method of drying and granulating is spray drying or vacuum drying.

Optionally, the operation of “uniformly coating bitumen on a surface of silicon-carbon composite material” comprises:

hot rolling after hot kneading the silicon-carbon composite material and the bitumen, crushing into a powder material after cooling, isostatic pressing the powder material to obtain block green body, crushing and sieving the block green body, and obtaining spherical silicon-carbon composite material particles with bitumen coated on the surface after mechanical fusion treatment.

Optionally, a temperature of the hot kneading is in a range of 100° C. to 300° C., and a time of the hot kneading lasts more than 1 hour;

a temperature of the hot rolling is in a range of 100° C. to 300° C.;

a pressure of the isostatic pressing is in a range of 150 MPa to 300 MPa, and a time of the isostatic pressing lasts more than 5 min;

a linear speed of the mechanical fusion is in a range of 20 m/s to 60 m/s, and a time of the mechanical fusion lasts in a range of 5 min to 60 min.

Optionally, the bitumen is coal bitumen or petroleum bitumen with a softening temperature greater than 70° C.

Optionally, the high-temperature carbonization treatment is carried out under an inert atmosphere, a carbonization temperature is in a range of 700° C. to 1100° C., and a carbonization time lasts more than 1 hour.

Optionally, a method of coating the conductive polymer is in-situ polymerization, liquid-phase coating of conductive polymer, or mechanical fusion coating of conductive polymer.

In one embodiment, a lithium ion battery is also disclosed, the negative electrode comprising the silicon-based composite material.

According to the silicon-based composite anode material provided by the present disclosure, a first shell layer and a second shell layer are formed on the outer layer of the inner core of the silicon-carbon composite material, the first shell layer comprises an amorphous carbon layer, and the second shell the layer comprises a conductive polymer layer. Wherein the amorphous carbon layer improves conductivity, restrains the volume expansion of the inner core, and has isotropic characteristics, improving the uniformity of lithium insertion. The conductive polymer layer can conduct electrons and lithium ions and has good toughness which avoids cracking of amorphous carbon layer during charging and discharging, and is beneficial to forming a stable SEI film, thereby improving the cycle stability of the material. The double-layer coating structure formed by amorphous carbon and conductive polymer T improves the strength and toughness of the coating layer, which not only restricts the volume expansion of the inner core, but also helps to build a stable solid-liquid interface and form a stable SEI film, thereby improving the cycle stability and rate performance of lithium ion batteries.

### DETAILED DESCRIPTION

To make the technical problems, technical solutions, and beneficial effects solved by the present invention clearer, the present disclosure is described in detail in combination with the embodiment. It will be understood that the exemplary embodiments described herein are only used for explanation, and not to limit.

One embodiment of the present disclosure provides a silicon-based composite negative electrode material, comprising an inner core, a first shell layer, and a second shell layer. The first shell layer covers the inner core, and the second shell layer covers the first shell;

the inner core comprises a silicon-carbon composite material;

the first shell layer comprises an amorphous carbon layer;

the second shell layer comprises a conductive polymer layer.

Wherein, the amorphous carbon layer improves conductivity, restricts the volume expansion of the core, exhibits isotropic characteristics, and improves the uniformity of lithium insertion. The conductive polymer layer can conduct electrons and lithium ions, has good toughness, and avoids the phenomenon of cracking of the amorphous carbon layer during charging and discharging, which is conducive to the formation of a stable SET film, thereby improving the cycle stability of the material. The double-layer coating structure formed by amorphous carbon and conductive polymer improves the strength and toughness of the coating layer, which can not only restrain the volume expansion of the core, but also help to build a stable solid-liquid interface and form a stable SEI film, thereby improving the cycle stability of the lithium ion battery.

In some embodiments, the silicon-based composite negative electrode material comprises the following components:

21.5 to 145 parts by weight of the inner core, 1 to 25 parts by weight of the first shell, and 0.5 to 20 parts by weight of the second shell layer.

The silicon-carbon composite material plays a role of deintercalating lithium ions during the charging and discharging process of the lithium ion battery, and various existing silicon-carbon composite materials can be used. To achieve better electrical performance, the existing silicon-carbon composite materials are improved. Some embodiments of the present disclosure provide a silicon-carbon composite material. The silicon-carbon composite material comprises nano-silicon, nano-conductive carbon, and graphite.

The silicon-carbon composite material provided in one embodiment adopts nano-scale silicon materials, which avoids the pulverization of the material and the loss of electrical contact during the charging and discharging process. Graphite is used as the framework material to achieve uniform dispersion of nano-silicon and avoid the electrochemical sintering phenomenon of nano-silicon. The graphite is also an active material and provides lithium storage capacity. By adding nano-conductive carbon to build a flexible three-dimensional conductive network and a fast lithium ion transmission network, the electronic and lithium ion conductivity of the core is improved, the rate characteristics of the material are improved, and the internal nano-silicon is prevented from losing electrical contact.

In some embodiments, a surface oxide layer SiOx with a thickness less than or equal to 3 urn is formed on a surface of the nano-silicon, wherein 0<X≤2.

In some embodiments, the nano-conductive carbon comprises one or more of carbon black, graphitized carbon black, carbon nanotubes, carbon fibers, and graphene.

In some embodiments, a particle size of the nano-silicon is in a range of 10 nm to 300 nm.

In some preferred embodiments, the particle size of the nano-silicon is in a range of 30 nm to 100 nm.

In some embodiments, the graphite comprises one or more of natural graphite, artificial graphite, and mesophase carbon microsphere graphite.

In some embodiments, the amorphous carbon layer is a soft carbon coating layer or a hard carbon coating layer with a thickness less than or equal to 3 μm,

In some embodiments, the conductive polymer layer comprises one or more of polyaniline, PEDOT: PSS, poly acetylene, polypyrrole, poly thiophene, poly (3-hexylthiophene), poly (p-phenylene vinylene), poly (pyridine), poly (phenylene vinylene), and derivatives of the above said conductive polymers.

In some embodiments, a thickness of the conductive polymer layer is less than or equal to 3 μm.

Another embodiment of the present disclosure provides a preparation method of the composite silicon anode material as described above, comprising the following operation steps:

uniformly coating bitumen on a surface of silicon-carbon composite material;

high-temperature carbonization treatment of the bitumen, forming an amorphous carbon layer on the surface of the silicon-carbon composite material; and

covering an outer surface of the amorphous carbon layer with a conductive polymer to obtain a conductive polymer layer and obtaining the composite silicon negative electrode material.

The preparation method is low in cost, simple, and easy to scale up industrially, and is beneficial to the large-scale application of silicon-based composite negative electrode materials. The silicon-based composite negative electrode material prepared by the preparation method has high sphericity, controllable particle size distribution, and is easy to achieve a high compaction density.

In some embodiments, the preparation method of the silicon-carbon composite material comprises:

dispersing nano-silicon in a solvent, obtaining nano-silicon dispersion by liquid-phase ball milling, then adding graphite and nano-conductive carbon, uniformly mixing by liquid-phase ball milling, drying and granulating an obtained slurry to obtain the silicon-carbon composite material.

In some embodiments, in the liquid-phase ball milling process, a grinding medium is a zirconia ball with a diameter of 0.05 mm to 1 mm, a ball-to-material mass ratio is in a range of 2:1 to 20:1, a rotating speed is in a range of 200 rpm to 1500 rpm, a ball milling time lasts in a range of 1 hour to 12 hours, and a material temperature is in a range of 25° C. to 35° C.

In some embodiments, a method of drying and granulating is spray drying or vacuum drying.

In some embodiments, the operation of “uniformly coating bitumen on a surface of silicon-carbon composite material” comprises:

hot rolling after hot kneading the silicon-carbon composite material and the bitumen, crushing into a powder after cooling, isostatic pressing of the powder to obtain block green body, crushing and sieving the block green body, and obtaining spherical silicon-carbon composite material particles with bitumen coated on the surface after mechanical fusion treatment. This method can ensure that the bitumen is evenly distributed on the surface of the silicon-carbon composite material particles, ensure the coating effect, and realize the sphericalization and isotropy of the particles. The isotropic coating structure can improve the consistency of the lithium insertion process and reduce the polarization phenomenon and the occurrence of lithium evolution during the charging and discharging process.

In some embodiments, a temperature of the hot kneading is in a range of 100° C. to 300° C. and a time of the hot kneading lasts more than 1 hour, preferably 2 hours.

A temperature of the hot rolling is in a range of 100° C. to 300° C., preferably in a range of 120° C. to 250° C.

It should be noted that in the early stage of hot kneading and hot rolling, if the temperature is too low, the viscosity of the asphalt will be too low, and it is difficult to form a fully-mixed coating. If the temperature is too high, it will easily lead to premature carbonization of the bitumen, which is not conducive to the subsequent formation of an amorphous carbon layer.

A pressure of the isostatic pressing is in a range of 150 MPa to 300 MPa, and a time of the isostatic pressing lasts more than 5 min;

A linear speed of the mechanical fusion is in a range of 20 m/s to 60 m/s, and a time of the mechanical fusion lasts in a range of 5 min to 60 min, preferably in a range of 15 min to 30 min.

In some embodiments, the bitumen is coal bitumen or petroleum bitumen with a softening temperature greater than 70° C.

In some embodiments, the high-temperature carbonization treatment is carried out under an inert atmosphere, a carbonization temperature is in a range of 700° C. to 1100° C., and a carbonization time lasts more than 1 hour, preferably 3 hours.

In some embodiments, a method of coating the conductive polymer is in-situ polymerization, liquid-phase coating of conductive polymer, or mechanical fusion coating of conductive polymer.

The following embodiments further illustrate the present disclosure.

First Embodiment

This embodiment is used to illustrate the silicon-based composite negative electrode material and the preparation method thereof disclosed in the present disclosure, comprising the following operation steps.

2 kg of nano-silicon powder with a median particle size of 100 nm is added into 18 kg of ethanol solvent, and after ultrasonic dispersion for 30 minutes, poured into a cavity of an ultrafine ball mill. A zirconia ball with a diameter of 0.6 mm is used as a ball milling medium, a ball-to-material ratio (mass ratio) is 6:1, and after being dispersed by ball milling at 800 rpm for 2 hours, a nano-silicon dispersion is obtained. 100 g of carbon nanotubes is added to the nano-silicon dispersion and dispersed by ball milling at 800 rpm for 1 hour. Then, 6.4 kg of flake graphite is added, and after being dispersed by ball milling at 800 rpm for 1 hour, a uniform mixed slurry is obtained. The mixed slurry is spray-dried to obtain powdery core material (nano-silicon/nano-conductive carbon/graphite composite particles).

2 kg of the powdery core material obtained by spray drying and 1 kg of modified bitumen are hot-kneaded at 170° C. for 2 hours; the kneaded product is hot-rolled at 190° C. to form a rubber-like shape with a thickness of about 3 mm, which is crushed into powder material after cooling; then the powder material is put into a rubber sheath, and isostatically pressed in an isostatic press at a pressure of 150 MPa for 10 minutes to obtain a block green body; then the block green body is crushed and sieved, and put into a mechanical fusion machine at a linear speed of 45 m/s for mechanical fusion for 10 minutes to obtain (nano-silicon/nano-conductive carbon/graphite) +bitumen composite particles; then calcined at 1050° C. for 3 hours under a protection of an inert atmosphere; after being broken up and sieved, a (nano-silicon/nano-conductive carbon/graphite) +amorphous carbon composite material with a silicon content of about 20% is obtained.

200 g of the (nano-silicon/nano-conductive carbon/graphite) +amorphous carbon composite material is added to 1 L of 1 mol/L hydrochloric acid solution and stirred and dispersed for 30 minutes. Then, 20 g of aniline is added at room temperature and stirring is continued for 30 minutes. Then, 1 L of 1 mon hydrochloric acid solution containing 56 g of ammonium persulfate is dripped into the mixed solution and stirring was continued for 4 hours after the addition is completed. Then, the mixed solution is filtered, washed, and vacuum dried at a temperature of 80° C. to obtain a silicon-based composite negative electrode material of (nano-silicon/nano-conductive carbon/graphite)+amorphous carbon+conductive polymer.

Second Embodiment

This embodiment is used to illustrate the silicon-based composite negative electrode material and the preparation method thereof disclosed in the present disclosure, comprising the following operation steps.

2 kg of nano-silicon powder with a median particle size of 100 nm is added into 18 kg of ethanol solvent, and after ultrasonic dispersion for 30 minutes, poured into a cavity of an ultrafine ball mill. A zirconia ball with a diameter of 0.6 mm is used as a ball milling medium, the ball-to-material ratio (mass ratio) is 6:1, and after being dispersed by ball milling at 800 rpm for 2 hours, a nano-silicon dispersion is obtained. 100 g of carbon nanotubes is added to the nano-silicon dispersion and dispersed by ball milling at 800 rpm for 1 hour. Then, 6.4 kg of flake graphite is added, and after being dispersed by ball milling at 800 rpm for 1 hour, a uniform mixed slurry is obtained. The mixed slurry is spray-dried to obtain powdery core material (nano-silicon/nano-conductive carbon/graphite composite particles).

2 kg of the powdery core material obtained by spray drying and 1 kg of modified bitumen are hot-kneaded at 170° C. for 2 hours; the kneaded product is hot-rolled at 190° C. to form a rubber-like shape with a thickness of about 3 mm, which is crushed into powder material after cooling; then the powder material is put into a rubber sheath, and isostatically pressed in an isostatic press at a pressure of 150 MPa for 10 minutes to obtain a block green body; then the block green body is crushed and sieved, and put into a mechanical fusion machine at a linear speed of 45 m/s for mechanical fusion for 10 minutes to obtain (nano-silicon/nano-conductive carbon/graphite) +bitumen composite particles; then, calcined at 1050° C. for 3 hours under a protection of an inert atmosphere; after being broken up and sieved, a (nano-silicon/nano-conductive carbon/graphite)+amorphous carbon composite material with a silicon content of about 20% is obtained.

200 g of the (nano-silicon/nano-conductive carbon/graphite)+amorphous carbon composite material is added to 1 L of 1 mol/L hydrochloric acid solution and stirred and dispersed for 30 minutes. Then, 50 g of pyrrole is added at room temperature and stirring is continued for 30 minutes. Then, 1 L of 1 mol/L hydrochloric acid solution containing 60 g ferric chloride is dripped into the above mixed solution and stirring was continued for 4 hours after the addition is completed. Then, the mixed solution is filtered, washed, and vacuum dried at a temperature of 80° C. to obtain a silicon-based composite negative electrode material of (nano-silicon/nano-conductive carbon/graphite)+amorphous carbon+conductive polymer.

Third Embodiment

This embodiment is used to illustrate the silicon-based composite negative electrode material and the preparation method thereof disclosed in the present disclosure, comprising the following operation steps.

2 kg of nano-silicon powder with a median particle size of 100 nm is added into 18 kg of ethanol solvent, and after ultrasonic dispersion for 30 minutes, poured into a cavity of an ultrafine ball mill. A zirconia ball with a diameter of 0.6 mm is used as a ball milling medium, a ball-to-material ratio (mass ratio) is 6:1, and after being dispersed by ball milling at 800 rpm for 2 hours, a nano-silicon dispersion is obtained. 100 g of conductive carbon black is added to the nano-silicon dispersion and dispersed by ball milling at 800 rpm for 1 hour. Then, 6.4 kg of flake graphite is added, and after being dispersed by ball milling at 800 rpm for 1 hour, a uniform mixed slurry is obtained. The mixed slurry is spray-dried to obtain powdery core material (nano-silicon/nano-conductive carbon/graphite composite particles).

2 kg of the powdery core material obtained by spray drying and 1 kg of modified bitumen are hot kneaded at 170° C. for 2 hours; the kneaded product is hot-rolled at 120° C. to form a rubber-like shape with a thickness of about 3 mm, which is crushed into powder material after cooling; then the powder material is put into a rubber sheath, and isostatically pressed in an isostatic press at a pressure of 150 MPa for 10 minutes to obtain a block green body; then the block green body is crushed and sieved, and put into a mechanical fusion machine at a linear speed of 45 m/s for mechanical fusion for 10 minutes to obtain (nano-silicon/nano-conductive carbon/graphite) +bitumen composite particles; then, calcined at 1050 for 3 hours under a protection of an inert atmosphere; after being broken up and sieved, a (nano-silicon/nano-conductive carbon/graphite)+amorphous carbon composite material with a silicon content of about 20% is obtained.

200 g of the (nano-silicon/nano-conductive carbon/graphite) +amorphous carbon composite material is added to 1 L of 1 mol/L hydrochloric acid solution and stirred and dispersed for 30 minutes. Then, 20 g of aniline is added at room temperature and stirring is continued for 30 minutes. Then, 1 L of 1 mol/L hydrochloric acid solution containing 56 g of ammonium persulfate is dripped into the mixed solution and stirring was continued for 4 hours after the addition is completed. Then, the mixed solution is filtered, washed, and vacuum dried at a temperature of 80° C. to obtain a silicon-based composite negative electrode material of (nano-silicon/nano-conductive carbon/graphite)+amorphous carbon+conductive polymer.

Fourth Embodiment

This embodiment is used to illustrate the silicon-based composite negative electrode material and the preparation method thereof disclosed in the present disclosure, comprises the following operation steps:

2 kg of nano-silicon powder with a median particle size of 100 nm is added into 18 kg of ethanol solvent, and after ultrasonic dispersion for 30 minutes, poured into a cavity of an ultrafine ball mill. A zirconia ball with a diameter of 0.6 mm is used as a ball milling medium, a ball-to-material ratio (mass ratio) is 6:1, and after being dispersed by ball milling at 800 rpm for 2 hours, a nano-silicon dispersion is obtained. 50 g of carbon nanotubes and 10 g of graphene is added to the nano-silicon dispersion and dispersed by ball milling at 800 rpm for 1 hour. Then, 6.4 kg of flake graphite is added, and after being dispersed by ball milling at 800 rpm for 1 hour, a uniform mixed slurry is obtained. The mixed slurry is spray-dried to obtain powdery core material (nano-silicon/nano-conductive carbon/graphite composite particles).

2 kg of the powdery core material obtained by spray drying and 1 kg of modified bitumen are hot kneaded at 170° C. for 2 hours; the kneaded product is hot-rolled at 190° C. to form a rubber-like shape with a thickness of about 3 mm, which is crushed into powder material after cooling; then the powder material is put into a rubber sheath, and isostatically pressed in an isostatic press at a pressure of 150 MPa for 10 minutes to obtain a block green body; then the block green body is crushed and sieved, and put into a mechanical fusion machine at a linear speed of 45 m/s for mechanical fusion for 10 minutes to obtain (nano-silicon/nano-conductive carbon/graphite) +bitumen composite particles; then calcined at 1050° C. for 3 hours under a protection of an inert atmosphere; after being broken up and sieved, a (nano-silicon/nano-conductive carbon/graphite)+amorphous carbon composite material with a silicon content of about 20% is obtained.

200 g of the (nano-silicon/nano-conductive carbon/graphite)+amorphous carbon composite material is added to I L of 1 mol/L hydrochloric acid solution and stirred and dispersed for 30 minutes. Then, 20 g of aniline is added at room temperature and stirring is continued for 30 minutes. Then, 1 L of 1 mol/L hydrochloric acid solution containing 56 g of ammonium persulfate is dripped into the mixed solution and stirring was continued for 4 hours after the addition is completed. Then, the mixed solution is filtered, washed, and vacuum dried at a temperature of 80° C. to obtain a silicon-based composite negative electrode material of (nano-silicon/nano-conductive carbon/graphite) +amorphous carbon +conductive polymer.

Fifth Embodiment

This embodiment is used to illustrate the silicon-based composite negative electrode material and the preparation method thereof disclosed in the present disclosure, comprises the following operation steps.

2 kg of nano-silicon powder with a median particle size of 100 nm is added into 18 kg of ethanol solvent, and after ultrasonic dispersion for 30 minutes, poured into a cavity of an ultrafine ball mill. A zirconia ball with a diameter of 0.6 mm is used as a ball milling medium, a ball-to-material ratio (mass ratio) is 6:1, and after being dispersed by ball milling at 800 rpm for 2 hours, a nano-silicon dispersion is obtained. Then, 6.4 kg of flake graphite is added, and after being dispersed by ball milling at 800 rpm for 1 hour, a uniform mixed slurry is obtained. The mixed slurry is spray-dried to obtain powdery core material (nano-silicon/graphite composite particles).

2 kg of the powdery core material obtained by spray drying and 1 kg of modified bitumen are hot kneaded at 170° C. for 2 hours; the kneaded product is hot-rolled at 190° C. to form a rubber-like shape with a thickness of about 3 mm, which is crushed into powder material after cooling; then the powder material is put into a rubber sheath, and isostatically pressed in an isostatic press at a pressure of 150 MPa for 10 minutes to obtain a block green body; then the block green body is crushed and sieved, and put into a mechanical fusion machine at a linear speed of 45 m/s for mechanical fusion for 10 minutes to obtain (nano-silicon/graphite)+bitumen) composite particles; then calcined at 1050° C. for 3 hours under a protection of an inert atmosphere; after being broken up and sieved, a (nano-silicon/graphite)+amorphous carbon composite material with a silicon content of about 20% is obtained.

200 g of the (nano-silicon/graphite)+amorphous carbon composite material is added to 1 L of 1 mol/L hydrochloric acid solution and stirred and dispersed for 30 minutes. Then, 20 g of aniline is added at room temperature and stirring is continued for 30 minutes. Then, 1 L of 1 mol/L hydrochloric acid solution containing 56 g of ammonium persulfate is dripped into the mixed solution and stirring was continued for 4 hours after the addition is completed. Then, the mixed solution is filtered, washed, and vacuum dried at a temperature of 80° C. to obtain a silicon-based composite negative electrode material of (nano-silicon/graphite)+amorphous carbon+conductive polymer.

First Comparative Embodiment

This comparative embodiment is used to compare and illustrate the silicon-based composite negative electrode material and the preparation method thereof disclosed in the present disclosure, comprising most of the operation steps of the first embodiment. The differences are:

the silicon-based composite negative electrode material is not coated with conductive polymer.

Second Comparative Embodiment

This comparative embodiment is used to compare and illustrate the silicon-based composite negative electrode material and the preparation method thereof disclosed in the present disclosure, comprising most of the operation steps of the first embodiment. The differences are:

the silicon-based composite negative electrode material is not subjected to bitumen coating and carbonization treatment, and no amorphous carbon coating is formed.

Performance Testing

The silicon-based composite negative electrode materials prepared in the first to fifth embodiments and the first and second comparative embodiments are all prepared using the following methods to prepare electrodes and test the electrochemical properties of the materials. The test results are shown in Table 1.

The silicon-based composite negative electrode material, a conductive agent and a binder are dissolved in a solvent at a mass percentage of 86:6:8, and a solid content is 30%. The binder adopts a 1:1 mass ratio of sodium carboxymethyl cellulose (CMC, 2 wt. % CMC aqueous solution) styrene butadiene rubber (SBR, 50 wt. % SBR aqueous solution) composite water-based binder. After thorough stirring, a uniform slurry is obtained. Coated on 10 μm copper foil, and dried at room temperature for 4 hours, punched into pole pieces with a punch with a diameter of 14 mm, pressed at a pressure of 100 kg/cm⁻², and dried in a vacuum oven at 120° C. for 8 hours.

The pole pieces are transferred to a glove box, and a button battery is assembled with metal lithium piece as a counter electrode, Celgard 2400 separator, 1 mol/L LiPF6/EC+DMC+EMC+2%VC (v/v/v=1:1:1) electrolyte and CR 2016 battery case. Constant current of the battery charge and discharge tests are carried out on Wuhan Jinnuo Land CT 2001 A battery test system, and a cut-off voltage of charge and discharge is 0. 005-2 V relative to Li/Li+.

The test results obtained are in Table 1.

TABLE 1

| | | Coulomb | | Improvement | Improvement | Improvement |
|---|---|---|---|---|---|---|
| | | efficiency | | ratio of | ratio of | ratio of |
| | | improvement | Improvement | reversible | reversible | reversible |
| | Reversible | ratio in the | ratio of cycle | capacity at | capacity at | capacity at 3 |
| | capacity in | first week (VS | stability (VS | 0.3 C (VS | 1 C (VS the | C (VS the |
| | the first week | the fifth | the fifth | the fifth | fifth | fifth |
| | at 0.1 C | embodiment) | embodiment) | embodiment) | embodiment) | embodiment) |
| First | 673 | 3.5% | 110% | 4.3% | 7.6% | 22.5% |
| embodiment | | | | | | |
| Second | 664 | 3.3% | 105% | 4.2% | 7.3% | 21.8% |
| embodiment | | | | | | |
| Third | 659 | 2.7% | 80% | 3.9% | 6.8% | 20.5% |
| embodiment | | | | | | |
| Fourth | 680 | 3.0% | 98% | 4.5% | 8.1% | 23.6% |
| embodiment | | | | | | |
| Fifth | 657 | 0 | 0 | 0 | 0 | 0 |
| embodiment | | | | | | |
| First | 680 | −1.6% | −75% | 3.2% | 6.3% | 19.7% |
| comparative | | | | | | |
| embodiment | | | | | | |
| Second | 671 | 1.8% | −88% | 2.8% | 4.7% | 14.5% |
| comparative | | | | | | |
| embodiment | | | | | | |

It can be seen from the test results in Table 1 that compared to the silicon-based composite negative electrode material coated with amorphous carbon alone or with conductive polymer alone, the double-layer coating structure provided by the technical solution of the present disclosure can more effectively improve the cycle stability of the negative electrode.

In addition, the core material nano-silicon/nano-conductive carbon/graphite composite particles provided by the present disclosure also have good electrical properties, which is beneficial to the improvement of the reversible capacity of the battery.

The above are only preferred embodiments and are not intended to limit the present disclosure. Any modifications, equivalent replacements, and improvements made within the spirit and principles of the present disclosure shall be included in the scope of protection.

1. A silicon-based composite negative electrode material, comprising an inner core, a first shell layer and a second shell layer, wherein the first shell layer covers the inner core, the second shell layer covers the first shell layer;
the inner core comprises a silicon-carbon composite material;
the first shell layer comprises an amorphous carbon layer; and
the second shell layer comprises a conductive polymer layer.

2. The silicon-based composite negative electrode material of claim 1, wherein the silicon-based composite negative electrode material comprises the following components:
21.5 to 145 parts by weight of the inner core, 1 to 25 parts by weight of the first shell, and 0.5 to 20 parts by weight of the second shell layer.

3. The silicon-based composite negative electrode material of claim 1, wherein the silicon-carbon composite material comprises nano-silicon, nano-conductive carbon, and graphite.

4. The silicon-based composite negative electrode material of claim 3, wherein the silicon-carbon composite material comprises the following components:
1 to 50 parts by weight of the nano-silicon, 0.5 to 15 parts by weight of the nano-conductive carbon, and 20 to 80 parts by weight of the graphite.

5. The silicon-based composite negative electrode material of claim 3, wherein a surface oxide layer SiOx with a thickness less than or equal to 3 nm is formed on a surface of the nano-silicon, wherein 0<X≤2.

6. The silicon-based composite negative electrode material of claim 3, wherein the nano-conductive carbon comprises one or more of carbon black, graphitized carbon black, carbon nanotubes, carbon fibers, and graphene.

7. The silicon-based composite negative electrode material of claim 3, wherein a particle size of the nano-silicon is in a range of 10 nm to 300 nm.

8. The silicon-based composite negative electrode material of claim 3, wherein the graphite comprises one or more of natural graphite, artificial graphite, and mesophase carbon microsphere graphite.

9. The silicon-based composite negative electrode material of claim 1, wherein the amorphous carbon layer is a soft carbon coating layer or a hard carbon coating layer with a thickness less than or equal to 3 μm.

10. The silicon-based composite negative electrode material of claim 1, wherein the conductive polymer layer comprises one or more of polyaniline, PEDOT: PSS, polyacetylene, polypyrrole, polythiophene, poly (3-hexylthiophene), poly (p-phenylene vinylene), poly (pyridine), poly (phenylene vinylene), and derivatives of the above said conductive polymers.

11. The silicon-based composite negative electrode material of claim 1, wherein a thickness of the conductive polymer layer is less than or equal to 3 μm.

12. A preparation method of the silicon-based composite negative electrode material of claim 1, comprising the following operation steps:
uniformly coating bitumen on a surface of silicon-carbon composite material;
high-temperature carbonization treatment of the bitumen, forming an amorphous carbon layer on the surface of the silicon-carbon composite material; and
covering an outer surface of the amorphous carbon layer with a conductive polymer to obtain a conductive polymer layer and obtaining the composite silicon negative electrode material.

13. The preparation method of the silicon-based composite negative electrode material of claim 12, wherein the preparation method of the silicon-carbon composite material comprises:
dispersing nano-silicon in a solvent, obtaining nano-silicon dispersion by liquid-phase ball milling, then adding graphite and nano-conductive carbon, uniformly mixing by liquid-phase ball milling, drying and granulating an obtained slurry to obtain the silicon-carbon composite material.

14. The preparation method of the silicon-based composite negative electrode material of claim 13, wherein in the liquid-phase ball milling process, a grinding medium is a zirconia ball with a diameter of 0.05 mm to 1 mm, a ball-to-material mass ratio is in a range of 2:1 to 20:1, a rotating speed is in a range of 200 rpm to 1500 rpm, a ball milling time lasts in a range of 1 hour to 12 hours, and a material temperature is in a range of 25° C. to 35° C. .

15. The preparation method of the silicon-based composite negative electrode material of claim 13, wherein a method of drying and granulating is spray drying or vacuum drying.

16. The preparation method of the silicon-based composite negative electrode material of claim 12, wherein the operation of “uniformly coating bitumen on a surface of silicon-carbon composite material” comprises:
hot rolling after hot kneading the silicon-carbon composite material and the bitumen, crushing into a powder material after cooling, isostatic pressing the powder material to obtain block green body, crushing and sieving the block green body, and obtaining spherical silicon-carbon composite material particles with bitumen coated on the surface after mechanical fusion treatment.

17. The preparation method of the silicon-based composite negative electrode material of claim 16, wherein a temperature of the hot kneading is in a range of 100° C. to 300° C., and a time of the hot kneading lasts more than 1 hour;
a temperature of the hot rolling is in a range of 100° C. to 300° C.;
a pressure of the isostatic pressing is in a range of 150 MPa to 300 MPa, and a time of the isostatic pressing lasts more than 5 min;
a linear speed of the mechanical fusion is in a range of 20 m/s to 60 m/s, and a time of the mechanical fusion lasts in a range of 5 min to 60 min.

18. The preparation method of the silicon-based composite negative electrode material of claim 12, wherein the bitumen is coal bitumen or petroleum bitumen with a softening temperature greater than 70° C.

19. The preparation method of the silicon-based composite negative electrode material of claim 12, wherein the high-temperature carbonization treatment is carried out under an inert atmosphere, a carbonization temperature is in a range of 700° C. to 1100° C., and a carbonization time lasts more than 1 hour.

20. The method for preparing the silicon-based composite negative electrode material of claim 12, wherein a method of coating the conductive polymer is in-situ polymerization, liquid-phase coating of conductive polymer, or mechanical fusion coating of conductive polymer.

21. (canceled).
